(19) United States
(12) Patent Application Publication
(10) Pub. No.: US 2017/0215643 A1
(43) Pub. Date: Aug. 3, 2017

(54) PORTABLE TEMPERATURE REGULATING FOOD CONVEYING DEVICE

(71) Applicant: Pearl Beach, Tulsa, OK (US)

(72) Inventor: Pearl Beach, Tulsa, OK (US)

(21) Appl. No.: 15/008,905

(22) Filed: Jan. 28, 2016

(51) Int. Cl. A47J 41/00; F25B 21/04

(52) U.S. Cl. CPC A47J 41/005; A47J 41/0083; F25B 21/04

(57) ABSTRACT

A portable temperature regulating food conveying device may include a lid and a base. The base may be coupled to four sidewalls which may extend up and away from the base. The sidewalls may each be coupled to two other sidewalls to form a generally rectangular prism shaped container which may define a cavity for receiving one or more food items and/or food containers. The lid may be coupled to the top of one or more sidewalls thereby allowing the lid to govern access to the cavity. A liner may be removably positioned within the cavity proximate to the base and sidewalls. One or more temperature modifying units may be in thermal communication with the cavity and the liner and may be configured to modify or to maintain the temperature of the cavity and items received within the cavity.

### FIELD OF THE INVENTION

This patent specification relates to the field of portable food conveyances. More specifically, this patent specification relates to food conveying devices that are portable and are able to regulate the temperature of food contained within the device.

### BACKGROUND

Insulated containers are frequently used to transport food items such as food and beverages. These containers are configured to receive food items while surrounding the items with a thermally insulating material. As the containers are transported, the temperature equilibrium between the environment of the container and the food items contained within is delayed by the thermally insulating material. Currently available insulated containers are at a relatively low price point tend to only delay the temperature equilibrium for a short time, while relatively high price point containers that are better able to delay the equilibrium are prohibitively expensive to the average consumer. Unfortunately, even the best insulated containers are only able to delay the inevitable temperature equilibrium resulting in undesirable or wasted food items.

In addition to the previously mentioned temperature equilibrium drawbacks, currently available insulated containers are difficult to clean and maintain. Food and other containments frequently appear to bond to the interior of the containers. Unless the containers are cleaned immediately after use, the interior can quickly develop undesirable odors and appearances. To add further difficulty, it is commonly difficult to see into the interiors of these containers during cleaning and normal use.

Therefore, a need exists for novel devices for transporting food items. There also exists a need for novel devices for transporting food items. There is a further need for novel devices that are able to maintain the temperature of food items to prevent temperature equilibrium between the environment of the container and the food items contained within. Finally, there exists a need for novel devices for transporting food items that are not difficult to clean and maintain.

### BRIEF SUMMARY OF THE INVENTION

A portable temperature regulating food conveying device for receiving one or more food items and/or food containers is provided. In some embodiments, the device may comprise a lid and a base. The base may be coupled to four sidewalls which may extend up and away from the base. The sidewalls may each be coupled to two other sidewalls to form a generally rectangular prism shaped container which may define a cavity for receiving one or more food items and/or food containers. The lid may be coupled to the top of one or more sidewalls thereby allowing the lid to govern access to the cavity. A liner may be removably positioned within the cavity proximate to the base and sidewalls. The device may comprise one or more temperature modifying units which may be configured to modify or to maintain the temperature of the cavity and items received within the cavity. A temperature modifying unit may be in thermal communication with the cavity and a liner within the cavity and may be configured to modify or to maintain the temperature of the cavity, the liner, and items received within the cavity and the liner cavity.

In some embodiments, a liner may comprise a liner base which may be coupled to four liner sidewalls which may extend up and away from the liner base. The liner sidewalls may each be coupled to two other liner sidewalls to form a generally rectangular prism shaped liner which may define a liner cavity for receiving one or more food items and/or food containers. In preferred embodiments, the liner cavity may fill or form the cavity of the device thereby allowing the liner cavity to function as the cavity when the liner is removably positioned within the cavity.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front perspective view of an example of a portable temperature regulating food conveying device according to various embodiments described herein.

FIG. 2 illustrates a rear perspective view of an example of a portable temperature regulating food conveying device according to various embodiments described herein.

FIG. 3 shows a sectional, through line 3-3 shown in FIG. 2, elevation view of an example of a portable temperature regulating food conveying device according to various embodiments described herein.

FIG. 4 depicts a perspective view of an example of a removable liner of a portable temperature regulating food conveying device according to various embodiments described herein.

FIG. 5 illustrates a perspective exploded view of an example of a temperature modifying unit according to various embodiments described herein.

FIG. 6 shows a block diagram of some electronic components of an example of a portable temperature regulating food conveying device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

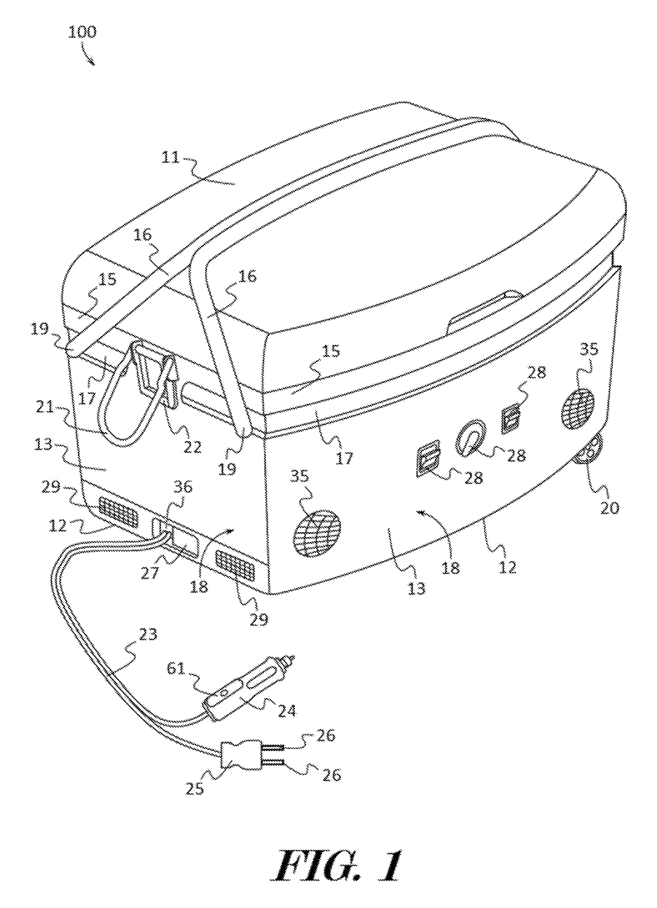

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New portable temperature regulating food conveying devices are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

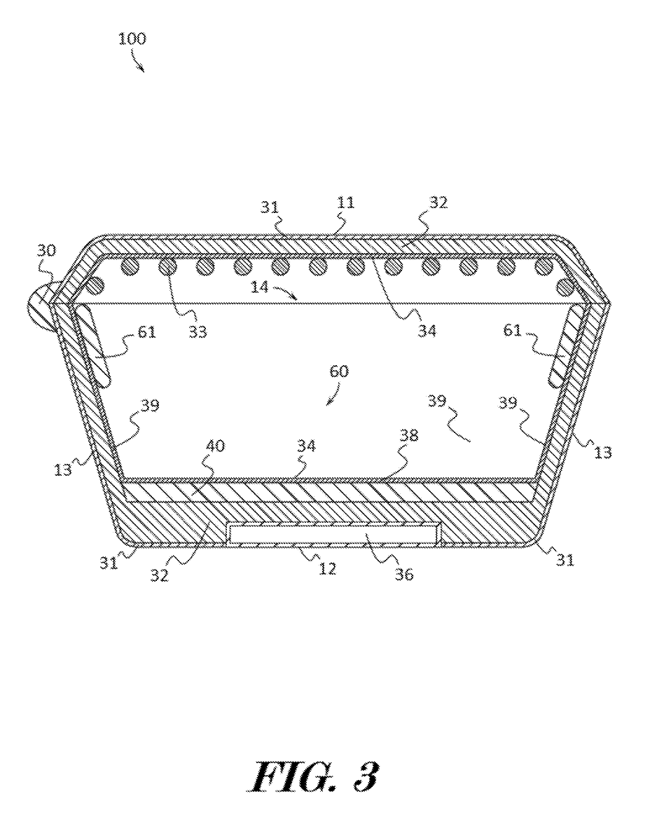

The present invention will now be described by example and through referencing the appended figures representing preferred and alternative embodiments. FIG. 1 illustrates an example of a portable temperature regulating food conveying device (“the device”) 100 according to various embodiments. In some embodiments, the device 100 may comprise a lid 11 and a base 12. The base 12 may be coupled to four sidewalls 13 which may extend up and away from the base 12. The sidewalls 13 may each be coupled to two other sidewalls 13 to form a generally rectangular prism shaped container which may define a cavity 14 (FIG. 3) for receiving one or more food items and/or food containers. The lid 11 may be coupled to the top 15 of one or more sidewalls 13 thereby allowing the lid 11 to govern access to the cavity 14.

In some embodiments, the device 100 may comprise one or more longitudinal handles 16. A longitudinal handle 16 may be coupled to two opposing sidewalls 13. In further embodiments, a longitudinal handle 16 may be pivotally coupled to two opposing sidewalls 13 thereby allowing the longitudinal handle 16 to pivot relative to the sidewalls 13, base 12, and/or lid 11. In still further embodiments, a longitudinal handle 16 may be slidably and/or pivotally coupled to two opposing sidewalls 13 thereby allowing the longitudinal handle 16 to slide and/or pivot and relative to the sidewalls 13, base 12, and/or lid 11.

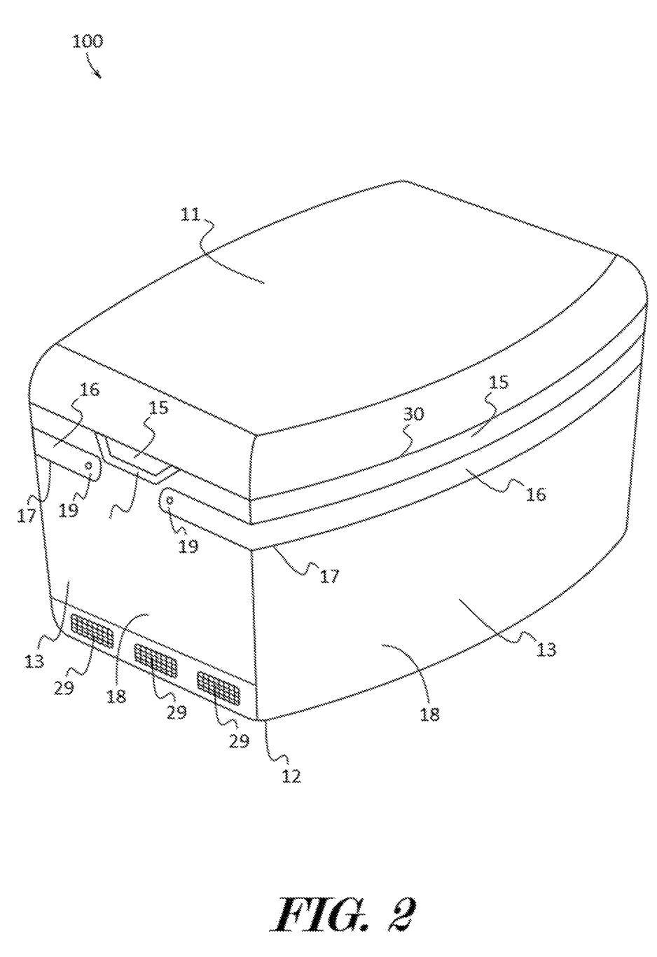

In some embodiments, the device 100 may comprise one or more handle channels 17. A handle channel 17 may be formed or coupled to one or more sidewalls 13 to form a depression into the sidewalls 13 into which portions of a longitudinal handle 16 may be received. When a longitudinal handle 16 is received into a handle channel 17, the longitudinal handle 16 may be generally flush with the exterior surface 18 of one or more sidewalls 13 as shown in FIG. 2. In further embodiments, each end 19 of a longitudinal handle 16 may be slidably and/or pivotally coupled to a handle channel 17 on two opposing sidewalls 13 thereby allowing the longitudinal handle 16 to slide and/or pivot and relative to the sidewalls 13, base 12, and/or lid 11. A longitudinal handle 16 may be to extended from the handle channel 17 and moved into a position suitable (FIG. 1) for carrying the device 100, and the longitudinal handle 16 may also be received into the handle channel 17 when the longitudinal handle 16 is not being used as shown in FIG. 2.

In some embodiments, the device 100 may comprise one or more, such as two, transportation conveyances 20 which may facilitate the movement of the device 100 across a surface by reducing friction between the base 12 and the surface, such as the ground or floor, over which the device 100 may be moved without requiring the person moving it to bear the full weight of the device 100. A transportation conveyance 20 may comprise a wheel, a caster, a tread or track, a low friction pad or bumper, a low friction plate, a ski, a pontoon, or any other suitable device configured to reduce the friction between the device 100 and the surface over which it is desired to be moved. The one or more optional transportation conveyances 20 may be substantially permanently joined or substantially temporarily joined to the base 12 and/or one or more sidewalls 13 of the device 100. In further embodiments, a transportation conveyance 20 may be retractably coupled to the base 12 and/or one or more sidewalls 13, thereby allowing a transportation conveyance 20 to be extended for use and retracted when not in use.

In some embodiments, the device 100 may comprise one or more elongate handles 21. An elongate handle 21 may be coupled, such as by being pivotally coupled, to a sidewall 13 and may be extended away from the sidewall 13. In further embodiments, an elongate handle 21 may be coupled to a first side of the device 100 while one or more transportation conveyances 20 may be coupled to an opposing side of the device 100. By extending portions of the elongate handle 21 away from the first sidewall 13, a user may grasp an extended portion of the elongate handle 21 and tow or push the device 100 to a desired location while the transportation conveyances 20 reducing friction between the base 12 and the surface, such as the ground or floor, over which the device 100 may be moved.

In some embodiments, the device 100 may comprise one or more lifting handles 22, each of which may be coupled to a sidewall 13. A lifting handle 22 may be movably coupled, such as by being pivotally and/or slidably coupled, to a sidewall 13 thereby allowing the lifting handle 22 to slide and/or pivot and relative to the sidewalls 13, base 12, and/or lid 11.

In some embodiments, the device 100 may comprise a power cord 23 of any length, such as between two feet and fifteen feet in length, which may be in electrical communication with one or more electronic components of the device 100. In further embodiments, the power cord 23 may be retractable and extendable from the base 12. For example, portions of the power cord 23 may be coupled to a retraction device, such as a spring loaded cable retractor, which may allow the power cord 23 to be extended and then maintained at various lengths from the base and then pulled quickly to initiate retraction of the power cord 23 into the base 12. In other embodiments, a device 100 may comprise one or more projections, such as which may be used as a cable maze, around which portions of the power cord 23 may be wrapped thereby securing the power cord 23 in a compact manner. By unwrapping portions of the power cord 23 from the one or more projections, a desired length of power cord 23 may be extended away from the base 12. In still further embodiments, a power cord 23 may be retractable and extendable from the base 12 and then maintained within portions of the base 12 by a cord gate 27. A cord gate 27 may be slidably engaged or otherwise movably coupled to the base 12 and/or sidewalls 13. When in a closed position, the cord gate 27 may deny access to the power cord 23, cigarette lighter adapter 24, and/or an electrical outlet plug 25, while when in an open position, the power cord 23, cigarette lighter adapter 24, and/or an electrical outlet plug 25 may be accessed and extended or retracted into the base 12.

In some embodiments, the power cord 23 may comprise a cigarette lighter adapter 24 and/or an electrical outlet plug 25. A cigarette lighter adapter 24 may be inserted into an outlet, such as a cigarette lighter socket or mobile socket, commonly found in vehicles, thereby allowing the cigarette lighter adapter 24 to electrically communicate power from the cigarette lighter socket to the power cord 23. An electrical outlet plug 25 may be inserted into an outlet, such as a wall outlet commonly found in and around structures, thereby allowing the electrical outlet plug 25 to electrically communicate power from the wall outlet to the power cord 23. In further embodiments, the pins 26 of an electrical outlet plug 25 may be retractable and extendable from the body of the electrical outlet plug 25. For example, the pins 26 may comprise a spring loaded device that when actuated may assist or cause the pins 26 to extend or retract from the electrical outlet plug 25. In another example, the pins 26 may be slidably coupled to the body of electrical outlet plug 25, such as with a push button mechanism that when pressed may allow the pins 26 to extend or retract from the electrical outlet plug 25, while locking the pins 26 into position when the push button mechanism is not pressed. In still further embodiments, a cigarette lighter adapter 24 and an electrical outlet plug 25 may be removably coupled to each other when not in use and to facilitate their storage. For example, a cigarette lighter adapter 24 and/or an electrical outlet plug 25 may comprise a clip, clamp, clasp, or other fastening device 61 which may be used to removably couple a cigarette lighter adapter 24 and an electrical outlet plug 25 together.

In some embodiments, the device 100 may comprise one or more control inputs 28 that a user may interact with such as turnable control knobs, depressable button type switches, slide type switches, rocker type switches, or any other suitable input that may be used to modulate the functions of one or more electrical components of the device 100. In further embodiments, a device 100 may comprise one or more vents 29. A vent 29 may comprise one or more apertures which may allow air to pass through a sidewall 13 and/or base 12. For example, a vent 29 may provide a fresh supply of air to a temperature modifying unit 40 within the device 100 thereby allowing the temperature modifying unit 40 to exchange heat with the air.

FIG. 2 illustrates a rear perspective view of an example of a portable temperature regulating food conveying device 100 according to various embodiments described herein. In some embodiments, the lid 11, base 12, and sidewalls 13 may be coupled together and configured to form a device 100 comprising a generally rectangular prism shape. In further embodiments, two opposing sidewalls 13 may comprise a generally flat planar shape while two other opposing sidewalls 13 may comprise a generally convex planar shape extending away from each other. Additionally, the lid 11 and/or base 12 may comprise one or more rounded corners or edges. In alternative embodiments, it should be understood to one of ordinary skill in the art that the lid 11, base 12, and/or sidewalls 13 may be configured in a plurality of sizes and shapes including square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

FIG. 3 shows a sectional, through line 3-3 shown in FIG. 2, elevation view of an example of a portable temperature regulating food conveying device 100 according to various embodiments described herein. A lid 11, base 12, and sidewalls 13, when aligned and brought together, may form a cavity 14 or space between into which items such as food items and containers may be positioned or received. In some embodiments, the lid 11 and a sidewall 13 may be flexible coupled together allowing portions of the lid 11 to pivot away from the sidewalls 13 and base 12 other while other portions of the lid 11 and a sidewall 13 may remain coupled together. A lid 11 may be flexibly coupled to a sidewall 13 with any suitable bendable attachment of the two elements, such as can be achieved by a hinged coupling 30.

In further embodiments, a hinged coupling 30 may comprise a butt hinge, butterfly hinge, flush hinge, barrel hinge, concealed hinge, continuous hinge, T-hinge, strap hinge, double-acting hinge, Soss hinge, a flexible material hinge, or any other type or style of hinge or pivotal joining method that allows portions of a lid 11 to be pivoted away from a sidewall 13 and/or base 12. In further embodiments, a hinged coupling 30 may comprise any type of hinge known in the art, including so-called “living” hinges, which typically comprise a linear, relatively flexible area between two relatively more rigid components, such as a line of thin plastic between thicker plastic portions, as is well known in the art. In still further embodiments, a hinged coupling 30 may comprise a spring or other tension providing device that is able to mechanically assist with the opening or closing of the lid 11. In other embodiments, a lid 11 and one or more sidewalls 13 may be slidably joined together with a tongue and groove engagement allowing portions of a lid 11 to be slid open and closed. In further embodiments, a lid 11 and one or more sidewalls 13 may be joined with any other type of engagement that allows a portion of a lid 11 to be moved relative to one or more sidewalls 13 thereby restricting and granting access to the cavity 14 of the device 100.

In some embodiments, the sidewalls 13, lid 11, and/or base 12 may comprise a durable exterior shell 31 which may be made from a durable material such as metal and metal alloys, plastic, natural and artificial rubber, resins, carbon fiber, wood, canvas and other durable fabrics, or any other material. In further embodiments, the sidewalls 13, lid 11, and/or base 12 may comprise an insulating material 32 which may be disposed or coupled to the interior of the durable exterior shell 31 to prevent temperature equilibrium between the environment of the device 100 and the items contained within the cavity 14 of the device 100. An insulating material 32 may comprise or be made from mineral wool, fiberglass, cellulose, polyurethane foam, polystyrene, Pyrogel, Polyisocyanurate, and natural fibers such as hemp, cellulose, cotton, or any other insulation material including combinations of materials. In still further embodiments, an insulating material 32 may be used to form vacuum pockets which may serve insulation purposes.

In some embodiments, the device 100 may comprise one or more light emitting elements 33 which may be coupled to a lid 11, base 12, and/or sidewall 11 and positioned to illuminate the cavity 14 with various colors and intensities of light. In some embodiments, a light emitting element 33 may comprise a light emitting diode (LED) which may be configured to provide light of various wavelengths and intensities. In other embodiments, a light emitting element 33 may comprise an organic light-emitting diode (OLED), incandescent light bulb, fluorescent light, bulb halogen light bulb, high-intensity discharge light bulb, laser light emitter, electroluminescent light source, neon light source, or any other type of suitable light source.

In some embodiments, the device 100 may comprise one or more liners 34 which may be removably positioned within the cavity 14. In further embodiments, the device 100 may comprise a first liner 34 which may be removably positioned proximate to the base 12 and sidewalls 13 and a second liner 34 which may be removably positioned proximate to the lid 11. Optionally, portions of one or more light emitting elements 33 may extend through or illuminate through portions of a liner 34 which may be removably positioned proximate to the lid 11.

In some embodiments, the device 100 may comprise one or more temperature modifying units 40 which may be configured to modify or to maintain the temperature of the cavity 14 and items received within the cavity 14. A temperature modifying unit 40 optionally may be positioned between a liner 34 and the insulating material 32 of the base 12, lid 11, and/or sidewall 13. A temperature modifying unit 40 may comprise an electric heating and cooling mechanism such as a Peltier chip, metal heat sink, and a fan which may relieve excess heat through one or more vents 29 (FIGS. 1 and 2). In other embodiments, a temperature modifying unit 40 may comprise various cooling means common in the art such as micro-refrigeration coils, freezer cool packs, chemical cool packs, cold stone panels, water ice, and dry ice may be used to cool the temperature the cavity 14. In further embodiments, a temperature modifying unit 40 may comprise various heating means common in the art such as electric heating elements, hot stone panels, and chemical heat packs may be used to heat the temperature of the cavity 14. In other alternative embodiments, a temperature modifying unit 40 may comprise one or more tubes configured to transmit a liquid across or through portions of a heat exchange element 112 and across or through portions of the cavity 14 modify or maintain the temperature of the cavity 14.

In some embodiments, the device 100 may comprise a component bay 36 which may be configured to receive one or more electrical components such as a power cord 23, cigarette lighter adapter 24, electrical outlet plug 25, power source 37, and/or processing unit 50. A component bay 36 may comprise a depression which may receive one or more electrical components which may be covered by a door or other portion of the base 12 and/or sidewall 13 thereby protecting electrical components within the component bay 36 from dirt, moisture, and other contaminants.

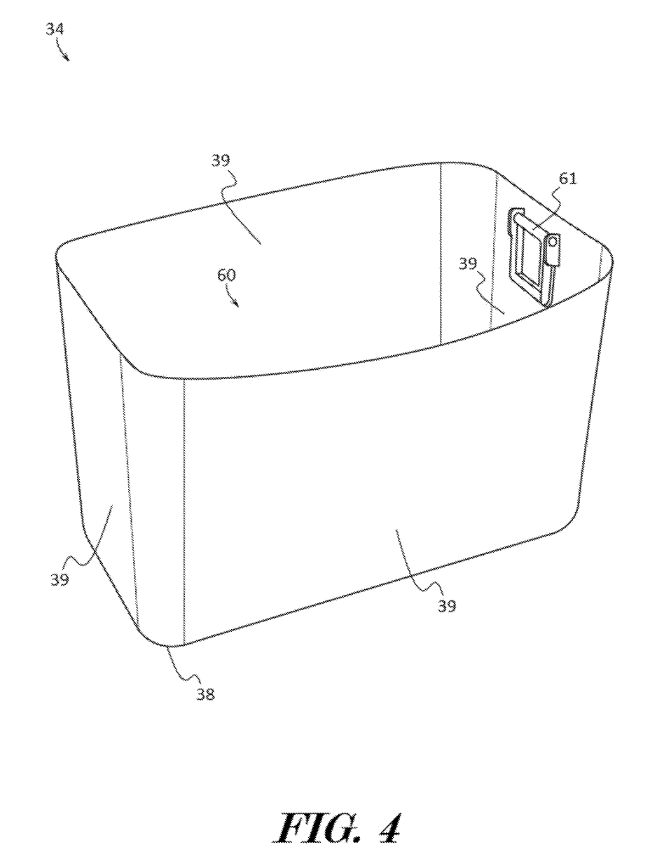

FIG. 4 depicts a perspective view of an example of a removable liner 34 of a portable temperature regulating food conveying device 100 according to various embodiments described herein. In some embodiments, a liner may comprise a liner base 38 which may be coupled to four liner sidewalls 39 which may extend up and away from the liner base 38. The liner sidewalls 39 may each be coupled to two other liner sidewalls 39 to form a generally rectangular prism shaped liner 34 which may define a liner cavity 60 for receiving one or more food items and/or food containers. In preferred embodiments, the liner cavity 60 may fill or form the cavity 14 (FIG. 3) of the device 100 thereby allowing the liner cavity 60 to function as the cavity 14 when the liner 34 is removably positioned within the cavity 14 as shown in FIG. 3.

In some embodiments, a liner 34 may be made from or comprise polytetrafluoroethylene (PTFE), polyethylene terephthalate (PET), high-density polyethylene (HDPE), polyvinyl chloride (PVC), polypropylene (PP), low density polyethylene (LDPE), Polyoxymethylene (POM), Ultra High Molecular Weight polyethylene, nylon, other plastics, metal and metal alloys, rubber, or any other material including combinations of materials. Preferably a liner 34 may be removably positioned within the cavity 14 of the device 100 during storage and transport of food and food containers and then removed to facilitate cleaning of the device 100.

In some embodiments, and a shown in FIGS. 3 and 4, a liner 34 may comprise one or more liner handles 61 each of which may be coupled to a liner sidewall 39. A liner handle 61 may be movably coupled, such as by being pivotally and/or slidably coupled, to a liner sidewall 39 thereby allowing the lifting handle 22 to slide and/or pivot and relative to the liner sidewall 39 and liner base 38. By grasping one or more liner handles 61, the insertion and removal of a liner 34 from the cavity 14 by a user may be facilitated. It should be understood to one of ordinary skill in the art that the liner sidewalls 39 and liner base 38 may be configured in a plurality of sizes and shapes including square shaped, rectangular shaped, cylinder shaped, cuboid shaped, hexagonal prism shaped, triangular prism shaped, or any other geometric or non-geometric shape, including combinations of shapes. It is understood that the terms and proposed shapes used herein are merely descriptive, rather than limiting, and that various changes, such as to size and shape, may be made without departing from the spirit or scope of the invention.

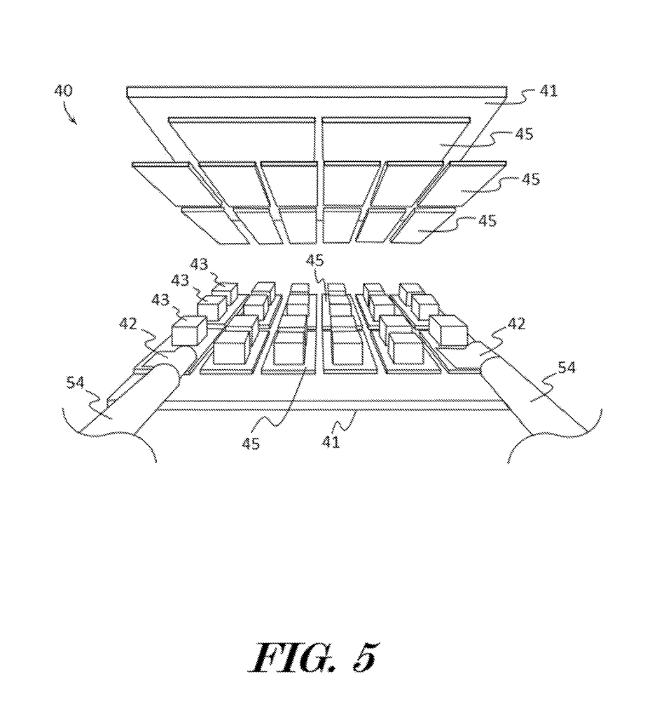

FIG. 5 shows a perspective exploded view of an example of a temperature modifying unit 40 according to various embodiments described herein. Each temperature modifying unit 40 is capable of maintaining a wide range of hot and cold temperatures. In preferred embodiments, the temperature unit 40 may comprise a thermoelectric heating and cooling element such as a Peltier chip as illustrated in FIG. 5 and may optionally comprise a metal heat sink, and a fan which may relieve excess heat through one or more vents 29 (FIG. 1). A peltier chip temperature modifying unit 40 may be configured to control the temperature of the cavity 14 in thermal connection with the temperature regulating surface 41 of the temperature modifying unit 40 thereby regulating the temperature within the cavity 14 (FIG. 3) of the device 100.

A Peltier chip uses the Peltier effect to create a heat flux between the junction of two different types of materials. A Peltier cooler, heater, or thermoelectric heat pump is a solid-state active heat pump which transfers heat from one side of the chip to the other, with consumption of electrical energy, depending on the direction of the current. Such an instrument is also called a Peltier device, Peltier heat pump, solid state refrigerator, or thermoelectric cooler (TEC). It can be used either for heating or for cooling, although in practice the main application is cooling. It can also be used as a temperature controller that either heats or cools. In other embodiments, a temperature modifying unit 40 may comprise various cooling means common in the art such as micro-refrigeration coils, freezer cool packs, chemical cool packs, cold stone panels, water ice, and dry ice may be used to cool the temperature of the cavity 14. In further embodiments, a temperature modifying unit 40 may comprise various heating means common in the art such as electric heating elements, hot stone panels, and chemical heat packs may be used to heat the temperature of the cavity 14.

A peltier chip temperature modifying unit 40 may comprise a first electrical junction 42 in electrical communication with a control switch 24 and a second electrical junction 42 in electrical communication with an electrical control switch 24. A plurality of two different semi-conductors 43, one n-type and one p-type, are placed thermally in parallel to each other and electrically in series with a plurality of conductors 45 and then joined with a temperature regulating surface 41 or thermally conducting plate on each side. When a voltage is applied to the electrical junctions 42 and to the free ends of the plurality of semiconductors 43 there is a flow of DC current across the junction of the semi-conductors 43 causing a temperature difference. The side with the cooling temperature regulating surface 41 absorbs heat which is then moved to the other temperature regulating surface 41 of the peltier chip which becomes hot resulting in a first temperature regulating surface 41 comprising a first temperature type and a second temperature regulating surface 41 comprising a second temperature type.

Once a temperature modifying unit 40 is activated, electric current may be supplied to a temperature modifying unit 40 which is configured to produce thermoelectric heating and cooling effects on a first temperature regulating surface 41 and a second temperature regulating surface 41. A temperature modifying unit 40 may produce a first temperature type such as a hot temperature type on a first temperature regulating surface 41 and a second temperature type such as a cold temperature type on a second temperature regulating surface 41. The temperature type of a temperature regulating surface 41 is dependent upon the direction of electrical current supplied to the temperature modifying unit 40 preferably with a control input 28 (FIG. 1) configured to send electrical current in a first direction to produce a first temperature type on a temperature regulating surface 41. The control input 28 may also be configured to send electrical current in a second direction to produce a different temperature type such as a cold temperature type on a first temperature regulating surface 41 and a second temperature type such as a hot temperature type on a second temperature regulating surface 41.

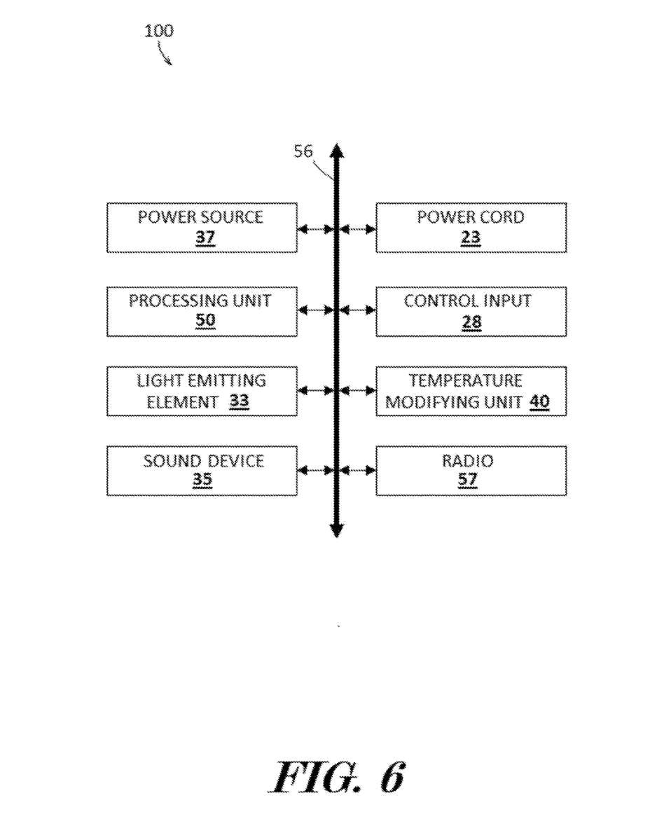

FIG. 6 shows a block diagram of some electronic components of an example of a portable temperature regulating food conveying device 40 according to various embodiments described herein. In some embodiments, the device 40 may comprise one or more electrical components such as a power source 37, power cord 23, processing unit 50, control input 28, light emitting element 33, sound device 35, a radio 57, and/or a temperature modifying unit 40.

In some embodiments, electrical communication between one or more electrical components may be provided by a local bus 56. In further embodiments, a local bus 56 may comprise a printed circuit board (PCB) which mechanically supports and electrically connects electronic components using conductive tracks, pads and other features etched from copper sheets laminated onto a non-conductive substrate. PCBs can be single sided (one copper layer), double sided (two copper layers) or multi-layer. Conductors on different layers may be connected with plated-through holes called vias. In some embodiments, a circuit board may only comprise copper connections and no embedded components and may be called a printed wiring board (PWB) or etched wiring board. In other embodiments, a circuit board may comprise a printed circuit assembly (PCA), printed circuit board assembly or PCB assembly (PCBA), a circuit card assembly (CCA), or a backplane assembly, or any other suitable electrical connection and communication method including standard wiring and the like.

The processing unit 50 may comprise a processor hardware device for executing software instructions. The processor can be any custom made or commercially available processor, a central processing unit (CPU), an auxiliary processor among several processors, a semiconductor-based microprocessor (in the form of a microchip or chip set), or generally any device for executing software instructions. When the device 100 is in operation, the processor of the processing unit 50 is configured to receive user input from a control input 28, optionally display information about the device 100 through a display or indicator, and to generally control operations of a temperature modifying unit 40. In an exemplary embodiment, the processing unit 50 may include a mobile optimized processor such as optimized for power consumption and mobile applications. The control inputs 28 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, indicator light, and the like. In some embodiments, a display device, such as an indicator light, may illuminate to indicate if the temperature modifying units 40 are activated to provide heating or cooling. For example, an LED indicator light may be illuminated for “HOT” and/or “COLD.” The control inputs 28 can also include, for example, a serial port, a parallel port, a small computer system interface (SCSI), an infrared (IR) interface, a radio frequency (RF) interface, a universal serial bus (USB) interface, and the like. The control inputs 28 can include a graphical user interface (GUI) that enables a user to interact with the device 100.

In some embodiments, the device 100 may comprise a power source 37 which may provide electrical power to a component that may require electrical power and to any other electronic device or electronics that may optionally be in electrical communication with a processing unit 50. A power source 37 may preferably be waterproof and may comprise a lithium ion battery, nickel cadmium battery, alkaline battery, or any other suitable type of battery. In further embodiments, a component bay 36 (FIG. 3) may be used to secure a rechargeable or non-rechargeable power source 37 which may or may not be removable from the component bay 36. In further embodiments, a power source 37 may be in electrical communication with a power cord 23, further comprising a cigarette lighter adapter 24 and/or a electrical outlet plug 25, which may be used to charge and provide electrical power to the power source 37.

An optional radio 23 enables wireless communication to an external access device or network. In some embodiments, a radio 23 may operate on a Bluetooth band and may communicate with one or more electronic devices over a wireless network allowing data to be sent and received by the radio 23. For example, a user may connect an electronic device such as a smart phone, tablet computer, and the like, to the radio 57 using a Bluetooth protocol. The electronic device may then transmit music data to the radio 57 which may then be output through one or more sound devices 35 to reproduce the music data in an audible format. Any number of suitable wireless data communication protocols, techniques, or methodologies can be supported by the radio 57, including, without limitation: RF; IrDA (infrared); AM/FM; WIFI; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

In some embodiments, the device 100 may comprise one or more sound devices 35 which may be configured to emit sounds. In preferred embodiments, a sound device 35 may comprise a speaker which may be used to produce a plurality of sounds at a plurality of volume levels. In other embodiments, a sound device 35 may comprise a buzzer, a piezoelectric sound producing device, a dielectric elastomer sound producing device, a buzzer, a moving coil loudspeaker, an electrostatic loudspeaker, an isodynamic loudspeaker, a piezo-electric loudspeaker, or any other device capable of producing one or more sounds. In some embodiments, a sound device 35 may be in wired communication with an electronic device through a wired input, such as a headphone jack, usb input, or other input, in electronic communication with the local bus 56 thereby allowing the electronic device to output sound and music through the sound device 35. In further embodiments, a sound device 35 may be in wireless communication with an electronic device through a wireless input, such as a radio 57, in electronic communication with the local bus 56 thereby allowing the electronic device to output sounds and music through the sound device 35.

While some materials have been provided, in other embodiments, the elements that comprise the device 100 such as the lid 11, base 12, sidewalls 13, handles 16, 21, 22, 61, optional cigarette lighter adapter 24, optional electrical outlet plug 25, optional cord gate 27, optional transportation conveyances 20, and/or any other element or component may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1) A portable temperature regulating food conveying device, the device comprising:
a lid
a base
four sidewalls coupled to and extending up and away from the base, wherein the sidewalls are each coupled to two other sidewalls to form a generally rectangular prism shaped container defining a cavity, and wherein the lid is coupled to the top of a sidewall to govern access to the cavity;
a liner, wherein the liner is removably positioned within the cavity proximate to the base and sidewalls; and
a temperature modifying unit which is configured to modify the temperature of the cavity wherein the temperature modifying unit is in thermal communication with the cavity and the liner positioned within the cavity.

2) The device of claim 1, wherein the temperature modifying unit contains a first electrical junction in electrical communication with an electrical control switch and a second electrical junction in electrical communication with the control switch, and a semiconductor positioned between said first and second electrical junctions.

3) The device of claim 2, wherein the temperature modifying unit is a thermoelectric heating and cooling element.

4) The device of claim 13, wherein the temperature modifying unit is a peltier chip.

5) The device of claim 1, wherein the lid comprises a plurality of lighting elements configured to illuminate the cavity.

6) The device of claim 5, wherein the plurality of lighting elements comprise light emitting diodes (LEDs).

7) The device of claim 1, wherein the liner comprises a liner base coupled to four liner sidewalls which may extend up and away from the liner base.

8) The device of claim 7, wherein the liner comprises a liner handle coupled to a liner sidewall.

9) The device of claim 1, further comprising an elongate handle pivotally coupled to a sidewall and wherein the elongate handle may be pivoted to extend away from the sidewall.

10) The device of claim 1, further comprising a lifting handle coupled to a sidewall.

11) The device of claim 1, further comprising a power cord which includes a cigarette lighter adapter 24 and an electrical outlet plug.

12) The device of claim 1, wherein the electrical outlet plug comprises a body, and wherein the pins of an electrical outlet plug are retractable and extendable from the body of the electrical outlet plug.

13) A portable temperature regulating food conveying device, the device comprising:
a lid
a base
four sidewalls coupled to and extending up and away from the base, wherein the sidewalls are each coupled to two other sidewalls to form a generally rectangular prism shaped container defining a cavity, and wherein the lid is coupled to the top of a sidewall to govern access to the cavity;
a liner, wherein the liner is removably positioned within the cavity proximate to the base and sidewalls, wherein the liner comprises a liner base coupled to four liner sidewalls which may extend up and away from the liner base, and wherein the liner comprises a liner handle coupled to a liner sidewall; and
a temperature modifying unit which is configured to modify the temperature of the cavity wherein the temperature modifying unit is in thermal communication with the cavity and the liner positioned within the cavity.

14) The device of claim 2, wherein the temperature modifying unit is a thermoelectric heating and cooling element.

15) The device of claim 13, wherein the temperature modifying unit is a peltier chip.

16) The device of claim 1, wherein the lid comprises a plurality of light emitting diode lighting elements configured to illuminate the cavity.

17) The device of claim 1, further comprising an elongate handle pivotally coupled to a sidewall and wherein the elongate handle may be pivoted to extend away from the sidewall.

18) The device of claim 1, further comprising a lifting handle coupled to a sidewall.

19) The device of claim 1, further comprising a power cord which includes a cigarette lighter adapter 24 and an electrical outlet plug.

20) The device of claim 1, wherein the electrical outlet plug comprises a body, and wherein the pins of an electrical outlet plug are retractable and extendable from the body of the electrical outlet plug.
